(19) United States
(12) Patent Application Publication
(10) Pub. No.: US 2017/0282324 A1
(43) Pub. Date: Oct. 5, 2017

(54) Two Stage Stainless Steel Media Sifter

(71) Applicant: Peter Vincent Lier, Hamden, CT (US)

(72) Inventor: Peter Vincent Lier, Hamden, CT (US)

(21) Appl. No.: 15/087,526

(22) Filed: Mar. 31, 2016

(51) Int. Cl. B24B 31/16; B08B 3/04; B07B 1/02; B24B 31/14; B24B 31/02

(52) U.S. Cl. CPC B24B 31/16; B24B 31/14; B24B 31/02; B07B 1/02; B08B 3/044; B07B 2201/04

(57) ABSTRACT

The present technology provides a product and process for efficiently separating ammunition casings from polishing media, preferably stainless steel pins, used in a cleaning process. A two stage sifting apparatus has first and second containers capable of nesting together. The upper first container has a bottom surface and sidewalls extending upwardly therefrom to an upper opening. The bottom surface has a plurality of openings smaller than the ammunition casings but larger than the polishing media. Through manipulation of the sifting apparatus, the polishing media escapes through the openings in the bottom surface of the first container and is retained in the second container. The containers are then separable, with the first container holding the casings and the second container holding the polishing media. Thereby, both the casings and the polishing media can be efficiently separated for re-use in the future, saving time and money.

### FIELD OF THE INVENTION

The technology relates to the field of cleaning ammunition casings for re-use. More specifically, the technology relates to using stainless steal media to clean ammunition casings for re-use and improving the process for separating the media from the ammunition casings after cleaning.

### BACKGROUND OF THE INVENTION

Many sportsmen who enjoy shooting for sport, for hunting, or for other purposes desire to re-use the casings from their ammunition. Casings, which may be made of brass, steel, etc., can often become expensive, driving up the cost of ammunition. And some sportsmen simply enjoy the process of loading their own ammunition. Accordingly, they may purchase casings separately or reload previously used casings.

When seeking to reload previously used casings, often the casings have been left on the ground for some time and have become dirty. In addition, the residue from the gun powder may remain on the casings after firing. Therefore, it is important to clean the casings prior to reloading them with ammunition to ensure proper performance.

Many products currently exist to assist in the cleaning process. In the past, ammunition casings may have been simply washed and rinsed clean by hand one at a time. Such a process was time-consuming and inefficient. Accordingly, products came to market seeking to improve on the cleaning process. The initial products that came to market for cleaning and polishing used casings were vibratory tumblers which agitate the used casings in a container of dry polishing media (such as corn cobs) to clean the spent casings. After the polishing step is completed, it is relatively easy to separate the polished metal casings from the polishing media by opening a drain hole in the vibratory tumbler, while it is still running, and allowing the media to drain from the tumbler bowl. Otherwise, a sifter could be used. Such systems are still in use.

A later developed product is an ultrasonic cleaning system, in which a basket of spent casings is placed in the tub of an ultrasonic cleaner, which contains a cleaning solution. The casings are then cleaned by ultrasonic cavitation using ultrasound. After the polishing step is completed, the basket of polished metal casings is lifted from the tub, easily separating the casings from the cleaning system. Such systems are still in use.

Another later developed product is a rotary tumbler which uses stainless steel polishing media (such as thin cylindrical pins). In these products, the spent casings are placed in a container along with the stainless steel polishing media, water, and/or cleaning solution; and the wet mixture is agitated by tumbling the mixture in the container in a rotary tumbler. Typically, the container is a hollow drum with each end being circular. For example, the drum may be a cylindrical drum, or it may have a hexagonal cross-section in its middle portions and have circular discs at each end. One or both of the circular ends may be a removable cap to allow the mixture to be placed in and removed from the drum. The hollow drum is laid on its side with the circular ends seated in the motorized wheels of a rotary tumbler to tumble the mixture until the casings are cleaned. During this process, the stainless steel pins strike the surface of both the inside and outside of the casing and polish the casings.

The polished casings are then separated from the rest of the mixture by pouring it in a strainer to separate the casings and pins from the liquid. Then the pins are removed from the casings using magnets to capture the pins. However, pins are frequently captured within the spent casings and can be require time and effort to remove from the casings. The process for separating the casings from the stainless steel pin media is inefficient. Thus, there exists a need in the art for an improvement on the process for separating ammunition casings from the stainless steel polishing media.

### SUMMARY OF THE INVENTION

Accordingly, it is an objective of the present technology to provide a product and process for separating media and a cleaning solution from cleaned ammunition casings. It is also an objective to provide a product and process that can separate the casings in a safe and efficient manner. It is further an objective of the present technology to ensure that the media itself can be re-used for additional cleaning in the future.

To accomplish these objectives, the present technology introduces an apparatus for separating polishing media from ammunition casings. The two stage sifting apparatus employs an upper first container having a bottom surface with sidewalls having a height extending upwardly therefrom to an upper opening. In some embodiments, the sidewalls extend upwardly perpendicular from the bottom surface. In some embodiments, the sidewalls extend upwardly at an angle, preferably no greater than forty-five degrees from perpendicular. The bottom surface of the first container is provided with a plurality of openings smaller than cleaned or polished casings and larger than the polishing media such that the casings can be separated from the polishing media when the polishing media passes through the holes in the bottom surface of the first container. In some embodiments, the upper opening of the first container has a peripheral lip with a lip cross-sectional profile, the lip extending outwardly from the sidewalls.

The two stage sifting apparatus also has a lower second container having a bottom surface with sidewalls having a height extending upwardly therefrom to an upper opening. Like the first container's sidewalls, the second container's sidewalls may extend upwardly perpendicular to the bottom surface in some embodiments; in other embodiments, the sidewalls may extend upwardly at an angle, preferably no greater than forty-five degrees from perpendicular. In those embodiments wherein the sidewalls of the first and second containers extend up from their respective bottom surfaces at an angle, it is preferable for the angles to match. The bottom surface of the second container is provided with a plurality of openings smaller than the polishing media such that the polishing media can be retained by the second container. In some embodiments, the bottom surface of the second container comprises a screen or mesh insert comprising the plurality of openings. In some embodiments, the upper opening of the second container has a peripheral rim with a rim cross-sectional profile contoured to receive the first container peripheral lip cross-sectional profile, the rim extending outwardly from the sidewalls.

The two stage sifting apparatus of the present technology operates by nesting the upper first container with the lower second container, whereby the a mixture of polished casings and stainless steel polishing media is agitated (stirred, shaken, or otherwise manipulated, by hand or otherwise) to cause the polishing media to escape through the plurality of holes in the bottom surface of the first container. The polished casings are retained within the first container while the polishing media is retained in the second container, and the containers can then be separated, each containing the separated casings and media respectively.

In some embodiments, the height of the sidewalls of the second container is greater than the height of the sidewalls of the first container, creating a space between the bottom surfaces of the first and second containers when nested together. This gap permits the polishing media to drop from the first container into the second container and be retained there. In some embodiments, the first container may be nested with the second container, with the first container's peripheral lip seated in the second container's peripheral rim. Those of skill in the art will recognize the variations available, and the present technology is not to be limited by the various embodiments and arrangements described herein.

By separating the polished casings in the first container, the casings, made of brass, steel, etc., can be removed, sorted, and reloaded. Similarly, by retaining the polishing media in the second container, the polishing media too can be re-used in future cleaning operations. In instances where water and/or a cleaning solution was used, the plurality of holes in the second container's bottom surface, comprised of a screen or mesh insert or otherwise, permit the water and/or cleaning solution to pass through the second container into a sink or other drainage system. Thereby, the user is left with two containers, one containing only ammunition casings and the other containing only polishing media.

In some embodiments, a plurality of feet may be provided on and extending downwardly from the second container. In some embodiments, a handle or handles may be provided on one of or both of the first and second containers. The handles may be used to assist in manipulating the sifting apparatus when the first and second containers are nested together. Further, the handles may be used to help separate the first container from the second container. In those embodiments wherein both the first and second containers have handles, the handle(s) of the first container are preferably generally vertically aligned with the handle(s) of the second container.

The present technology also introduces a system and method for using the above described sifting apparatus to separate casings from polishing media, stainless steel or otherwise. The method includes introducing a mixture of ammunition casings, polishing media, and optionally some combination of water, soap, cleaning solution, etc. into the two stage sifting apparatus. The user then agitates or manipulates (e.g. shaking, stirring, etc.) the sifting apparatus containing the mixture to facilitate the separation of the polishing media from the first container. In some embodiments, the manipulation of the sifting apparatus is facilitated through use of handles provided on either or both of the first and second containers. Once all the polishing media falls through the plurality of holes in the bottom surface of the first container, the first container is separated from the second container. Thereby, the first container containing only casings is separated from the second container containing only polishing media, and both the casings and polishing media can be re-used in accordance with the objectives of the present technology. The casings can be removed and sorted for reloading and the polishing media can be prepared for re-use in further cleaning processes. Those skilled in the art will recognize the variations available, and the present technology is not to be limited by the various steps and arrangements described herein.

In some embodiments, the method further comprises using a rotary tumbler to clean the casings (made of brass, steel, etc.) in the first instance. Such rotary tumblers typically comprise a re-closable drum or jar which contains the mixture of casings, polishing media (in the form of stainless steel pins or otherwise), and some combination of water, soap, cleaning solution, etc. In some embodiments, the re-closable drum or jar may be seated in the motor-driven wheels of a rotary tumbler, which act to agitate the re-closable jar and clean the casings contained within. In some embodiments, a user may agitate a re-closable jar by hand to clean the casings. Applicable devices may utilize a tumbling motion in combination with stainless steel polishing media to achieve excellent cleaning results. Other embodiments may utilize a vibratory process. Those skilled in the art will appreciate the various approaches available. Once the cleaning process is completed, the mixture is transferred into the two stage sifting apparatus described above, and the polished casings are thereby separated from the polishing media.

Similarly, the present technology introduces a system for performing the described method. The system uses a rotary tumbler to clean the casings according to the method described above. The mixture of casings, polishing media, and fluids (if used) is then transferred into the two stage sifting apparatus and manipulated to facilitate separation of the polishing media into the second container while the casings remain in the first container. The first container is then separated from the second, in some embodiments using the handles, and the casings can then be removed and sorted for re-use. Similarly, the polishing media can be removed from the second container and re-used in future cleaning operations.

Those skilled in the art will appreciate the many alterations possible to the presently described technology. The present technology is not limited to the embodiments and arrangements described above. Other objects of the present technology and its particular features and advantages will become more apparent from consideration of the following drawings and accompanying detailed description.

### BRIEF DESCRIPTION OF THE DRAWINGS

FIG. 1 is a perspective view of the sifting apparatus according to exemplifying embodiments of the present technology, wherein the upper first container and lower second container have been separated.

FIG. 2 is a perspective view of the sifting apparatus according to the exemplifying embodiment of the present technology depicted in FIG. 1, the apparatus in the nested, single unit state.

FIG. 3 is a perspective, cross-sectional view of the sifting apparatus in the nested, single unit state according to the exemplifying embodiment of the present technology depicted in FIG. 1.

FIG. 3A is a perspective, cross-sectional detail view of the lip and rim of the upper first container and lower second container, respectively, according to the exemplifying embodiment of the present technology depicted in FIG. 1.

FIG. 4 is a perspective view of the first upper first container according to the exemplifying embodiment of the present technology depicted in FIG. 1.

FIG. 5 is a perspective view of the sifting apparatus according to the exemplifying embodiment of the present technology depicted in FIG. 1 along with a rotary tumbler with a sealable drum or jar containing a mixture of at least ammunition casings and polishing media.

FIG. 6 is a perspective view of the sifting apparatus according to the exemplifying embodiment of the present technology depicted in FIGS. 1 and 5, wherein the contents of a sealable drum or jar, including at least casings and polishing media, are being emptied into the sifting apparatus.

FIG. 7 is a perspective view of the sifting apparatus according to the exemplifying embodiment of the present technology depicted in FIG. 1, wherein water is being used to rinse the contents of the sifting apparatus, including at least casings and polishing media.

FIG. 8 is a perspective view of the sifting apparatus according to the exemplifying embodiment of the present technology depicted in FIG. 1 containing at least casings and polishing media.

FIG. 9 is a perspective view of the sifting apparatus according to the exemplifying embodiment of the present technology depicted in FIG. 1 containing at least casings and polishing media, wherein the apparatus is being shaken to agitate the contents of the apparatus.

FIG. 10 is a perspective view of the sifting apparatus according to the exemplifying embodiment of the present technology depicted in FIG. 1, wherein the upper first and lower second containers have been separated, the upper first container retaining the casings and the lower second container retaining the polishing media.

### DETAILED DESCRIPTION OF THE INVENTION

The following detailed description illustrates the technology by way of example, not by way of limitation of the principles of the invention. This description will enable one skilled in the art to make and use the technology, and describes several embodiments, adaptations, variations, alternatives and uses of the invention, including what is presently believed to be the best mode of carrying out the invention. One skilled in the art will recognize alternative variations and arrangements, and the present technology is not limited to those embodiments described hereafter.

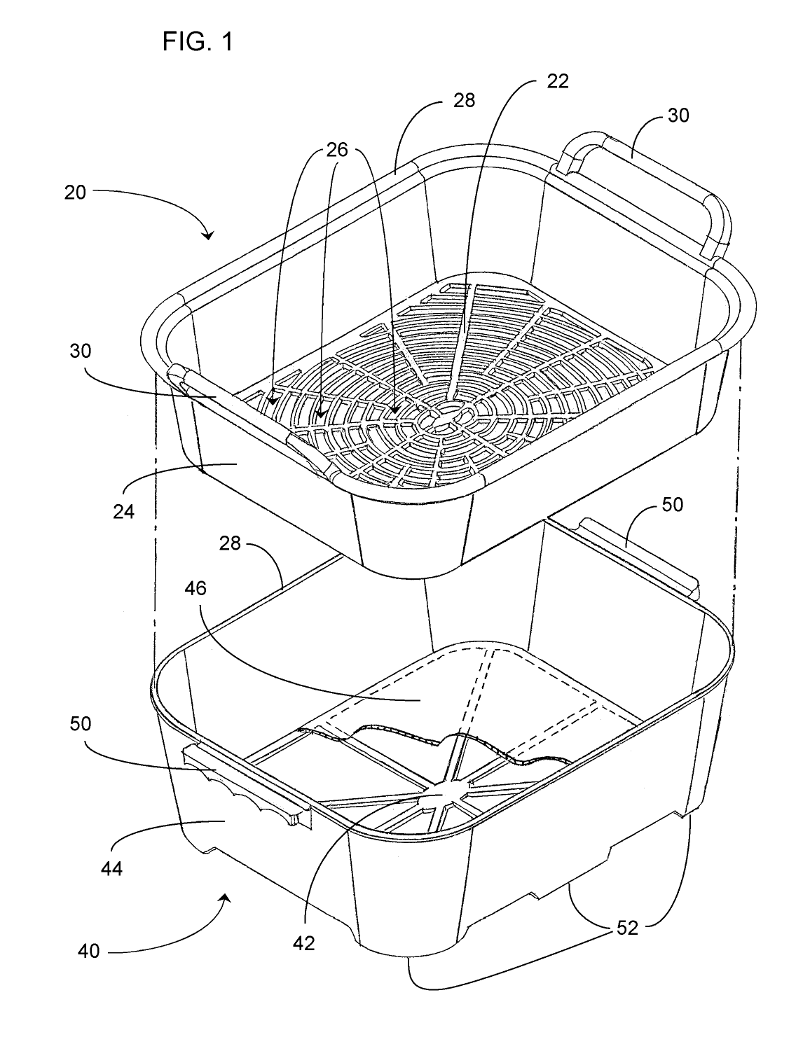

Referring to the figures in detail and first to FIG. 1, illustrated is an exemplary embodiment of a sifting apparatus 10 according to the present technology's teachings. The sifting apparatus 10 comprises an upper first container 20 and a lower second container 40. In the embodiment depicted in FIG. 1, the upper first container 20 is separated from the lower second container 40. As shown, the upper first container 20 comprises a bottom surface 22 and sidewalls 24 extending upwardly therefrom to an upper opening. The upper first container's 20 bottom surface 22 comprises a plurality of openings 26 sized smaller than ammunition casings 4 but larger than polishing media 6 such that the casings 4 are retained in the upper first container 20 while the polishing media 6 passes through the bottom surface 22 and into the lower second container 40. The particular design of the plurality of openings 26 in the upper first container's 20 bottom surface 22 is variable and not limited to that depicted in the figures. Those skilled in the art will recognize various arrangements and designs to affect the strength and integrity of the bottom surface 22.

Also illustrated in FIG. 1 is the lower second container 40, which likewise comprises a bottom surface 42 and sidewalls 44 extending upwardly therefrom to an upper opening. The lower second container's 40 bottom surface 42 also comprises a plurality of openings with variable designs. The openings on the bottom surface 42 of the lower second container 40 are sized smaller than polishing media 6 but permit passage of fluids such as water, soap, cleaning solution, etc. The bottom surface may this be a metal or plastic sheet with a plurality of small holes. In some embodiments, including that depicted in FIG. 1, the bottom surface 42 of the lower second container 40 comprises a mesh insert 46. The mesh insert 46 may be a metal or plastic screen or mesh. A mesh screen fabricated from aluminum, nylon or any other plastic would be suitable as a mesh insert 46. Mesh insert 46 permits the passage of fluid but retains polishing media 6, allowing the user to collect the polishing media for reuse and accomplishing certain objectives of the present technology. In an optional embodiment, the mesh insert 46 or bottom surface 42 comprises a magnetized material.

As seen in FIG. 1, in some embodiments, the sifting container according to the present technology further comprises one or more handles 30, 50. In some embodiments, the upper first container 20 has one set of handles 30 and the lower second container 40 has a second set of handles 50. Preferably, the first and second container's sets of handles are generally vertically aligned. In such embodiments, both sets of handles assist the user in operating the sifting apparatus. The second container's 40 set of handles 50, alone or in combination with the first container's 20 set of handles 30, can be used to manipulate the sifting apparatus by shaking, etc. to encourage separation of the ammunition casings 4 and polishing media 6. Once the casings 4 and polishing media 6 have been adequately separated, the set of handles 30 on the upper first container 20 can be used to separate the upper first container 20 from the lower second container 40. Thereby, the ammunition casings 4 contained in the upper first container 20 are separated from the polishing media 6 contained in the lower second container 40 and each can be reused, accomplishing certain objectives of the present technology.

Further, in some embodiments, including that depicted in FIG. 1, the lower second container may comprise feet 52. The feet 52 assist the drainage of fluids, such as water, soap, and/or cleaning solution, from the polishing media 6 contained in the lower second container 40. For example, the lower second container 40 may be placed in a sink or other drainage device. The feet 52 create space between the bottom surface 42 of the lower second container 40 and the surface of the drainage device, permitting easier passage of fluids.

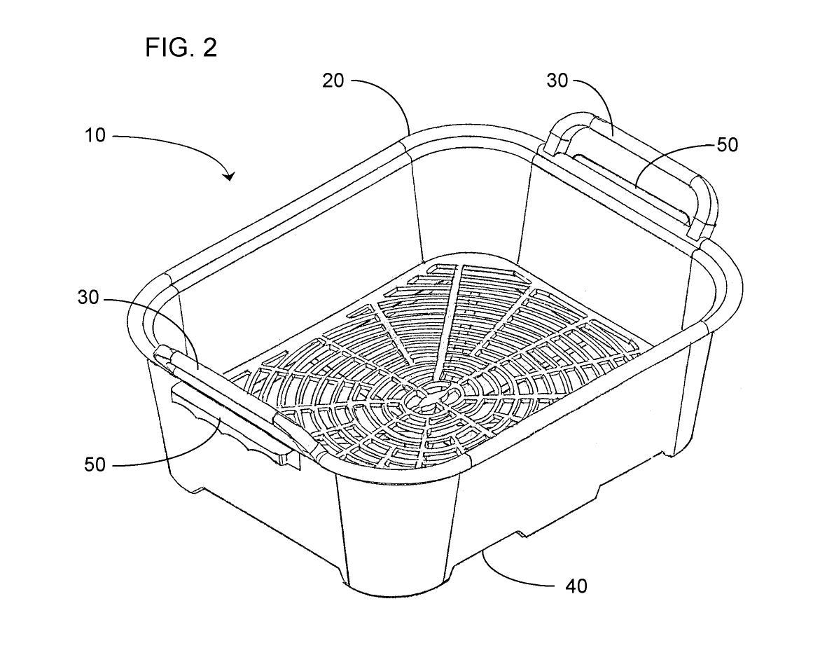

Referring next to FIG. 2, the sifting apparatus 10 is depicted in the nested, single-unit state, wherein the upper first container 20 is nested within the lower second container 40. When nested as depicted in FIG. 2, the sifting apparatus 10 can be manipulated as a single unit, for example when ammunition casings 4 and polishing media 6 have been introduced. The sifting unit 10 can be manipulated (shaken, etc.) as a single unit to encourage separation of the ammunition casings 4 from the polishing media 6. When the sifting apparatus 10 is manipulated, the polishing media 6 is small enough to pass through the plurality of openings 26 in the bottom surface 22 of the upper first container 20 while the ammunition casings 4 are not. Thus, the ammunition casings 4 are retained in the upper first container 20 while the polishing media 6 passed into the lower second container 40 where it too is retained. Thereafter, the upper first container 20 can be separated from the lower second container 40, thereby separating the casings 4 and polishing media 6 and accomplishing certain objectives of the present technology.

As illustrated in FIG. 2, the upper first container's 20 set of handles 30 may be generally vertically aligned with the lower second container's 40 set of handles 50. Such an arrangement is preferable because it permits the user to use both sets of handles 30, 50 when manipulating the sifting apparatus. Likewise, the handles 30, 50 assist the user in separating the upper first container 20 from the lower second container 40 once the ammunition casings 4 and polishing media 6 have been separated.

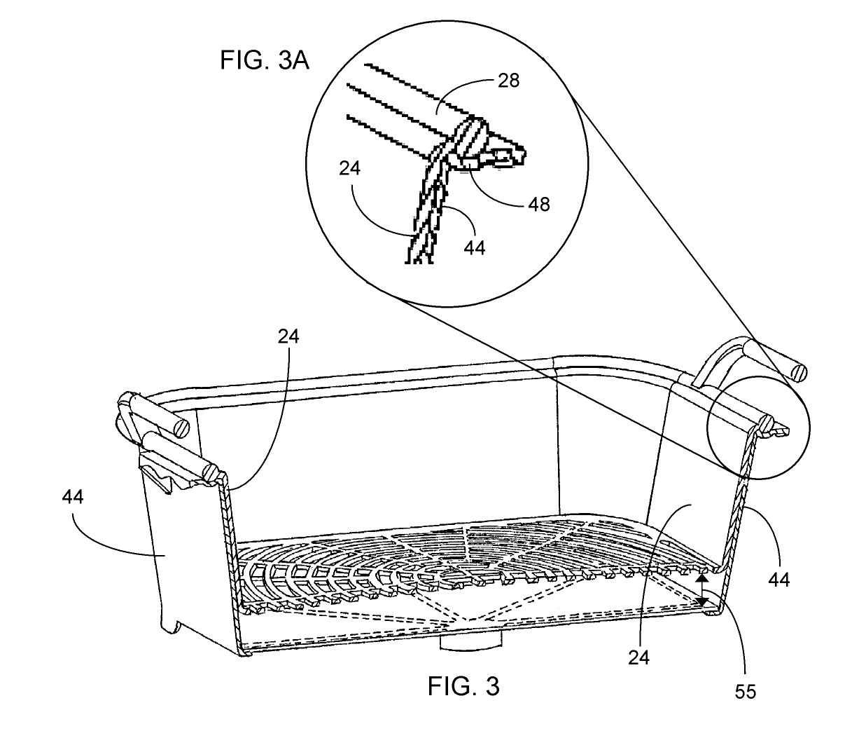

Referring next to FIGS. 3 and 3A, a cross-section of the sifting apparatus 10 is depicted, the apparatus in the nested, single-unit state. As depicted, the sidewalls 24, 44 of the first and second containers extend upward from the respective bottom surfaces 22, 42 at an angle slightly off from perpendicular. In some embodiments, the sidewalls 24, 44 extend perpendicular to the respective bottom surfaces 22, 24. In other embodiments, the sidewalls 24, 44 may extend at an angle greater than that depicted, preferably no greater than forty-five degrees from perpendicular. Regardless of the angle and as depicted, it is preferable that the sidewalls 24 of the upper first container 20 extend upwardly from the bottom surface 22 at the same angle as the sidewalls 44 of the lower second container 40 such that the length of the sidewalls 24, 44 are substantially adjacent.

Likewise, it is preferable that the height of the sidewalls 24 of the upper first container 20 is smaller than the height of the sidewalls 44 of the lower second container 40, as illustrated in FIG. 3. Thereby, a space or gap 55 is created between the respective bottom surfaces 22, 42 of the first and second containers, providing an area for the polishing media 6 to sit once it has been separated from the ammunition casings 4 retained by the upper first container 20. In some embodiments, the same gap 55 may be created by the circumferential sizes of the upper first container 20 and the lower second container 40 such that the tight fit of the first container 20 within the second container 40 causes a gap 55 between the respective bottom surfaces 22, 24. In such embodiments, the height of the respective sidewalls 24, 44 may be equal or otherwise. Those of skill in the art will recognize other variations and arrangements of the parts specified, and the present technology is not limited to those embodiments and arrangements depicted and described herein.

Referring next to FIG. 3A, a detail cross-section of the sidewalls 24, 44 near the upper openings of the first and second containers is illustrated. In some embodiments, as illustrated, the upper opening of the upper first container 20 has a peripheral lip 28 with a lip cross-sectional profile, the lip 28 extending outwardly from the sidewalls 24. Likewise, in some embodiments, the upper opening of the lower second container 40 has a peripheral rim 48 with a peripheral rim cross-sectional profile, the rim 48 extending outwardly from the sidewalls 44. As illustrated, the lip 28 may be adapted to fit in the rim 48, such that the lip 28 is seated in the rim 48 when the upper first container 20 is nested within the lower second container 40. In some embodiments, as depicted, the first container's 20 peripheral lip 28 is generally cylindrical with a cross-sectional profile that is circular, and the second container's 40 peripheral rim 48 has a cross-sectional profile that includes a curved groove for receiving the generally cylindrical peripheral lip 28. Those of skill in the art will recognize alternative arrangements and designs.

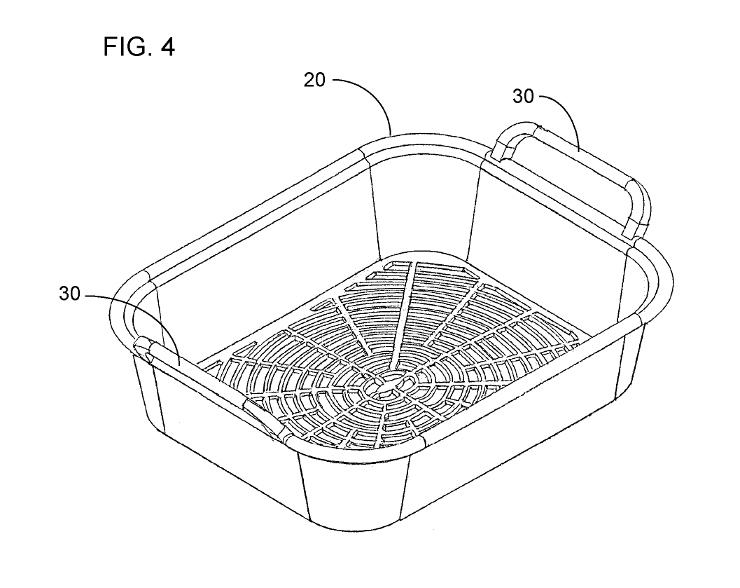

Referring next to FIG. 4, the sifting apparatus 10 is shown with the upper first container 20 separated from the lower second container 40. After the sifting apparatus 10 has been used to separate ammunition casings 4 from polishing media 6, the upper first container 20 is separated from the lower second container 40—using the handles 30 in some embodiments—so that the ammunition casings 4 retained in the upper first container 20 can be removed for reuse. Likewise, the polishing media 6 retained in the lower second container 40 can be removed for reuse. Thereby, objectives of the present technology are achieved.

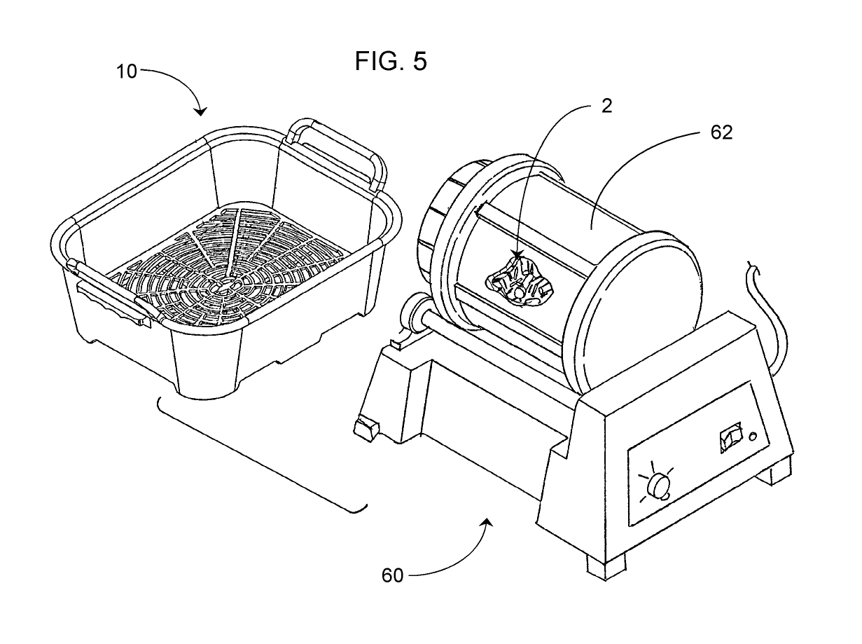

Referring now to FIG. 5, a sifting apparatus 10 according to the teachings of the present technology is illustrated in the nested, single-unit state along with a rotary tumbler 60. The rotary tumbler may be used to perform a cleaning or polishing process on a mixture 2 of at least ammunition casings 4 and polishing media 6. In some embodiments, fluids 8 such as water, soap, cleaning solution, etc. may be added to the mixture 2 to assist with the cleaning process. As illustrated in FIG. 5, the mixture 2 is added to a re-closable jar 62. The re-closable jar 62 is then placed on the rotary tumbler 60, which operates to manipulate the re-closable jar 62 using a tumbling, shaking motion. Thereby, the mixture 2 inside the re-closable jar 62 is stirred, performing the cleaning process. As noted, other means of manipulating the re-closable jar 62 are available, including manual shaking. Other manners of cleaning the mixture 2 of ammunition casings 4 and polishing media 6 are also available and will be well known to those skilled in the art.

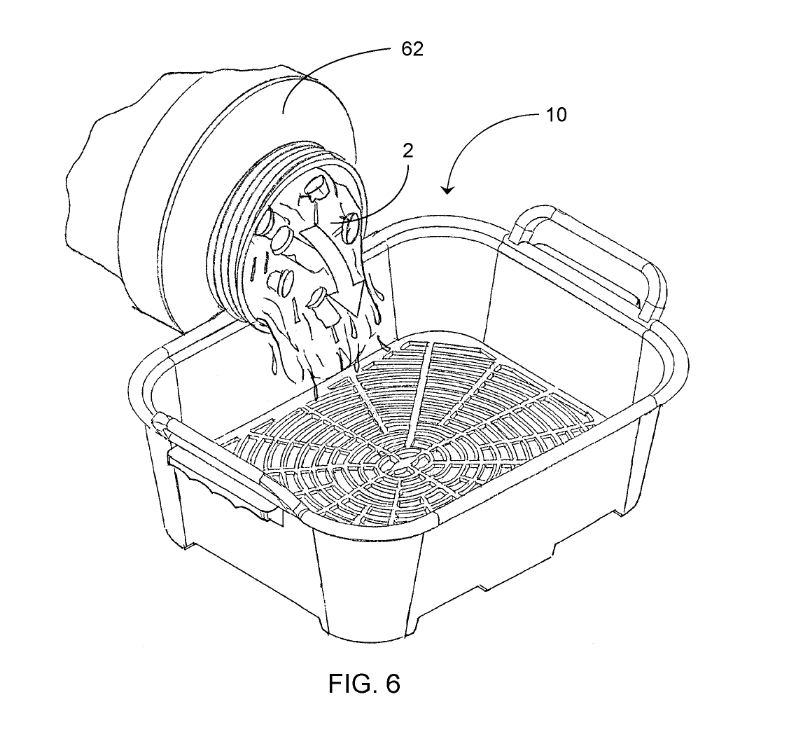

Referring next to FIG. 6, once the mixture 2 has been manipulated within the re-closable jar 62 sufficiently to polish the casings 4 (using a rotary tumbler or otherwise), the mixture 2 containing at least ammunition casings 4 and polishing media 6 is poured from the re-closable jar 62 into the sifting apparatus 10. Preferably, the sifting apparatus 10 is in the nested, single-unit state at this point in the process, whereby the upper first container 20 is nested within the lower second container 40. This state ensures that all casings 4 and polishing media 6 are retained by the sifting apparatus 10. In instances where the mixture 2 contains fluids 8, preferably the sifting unit is placed within or held above a draining device, such as a sink, to avoid spillage of the fluid.

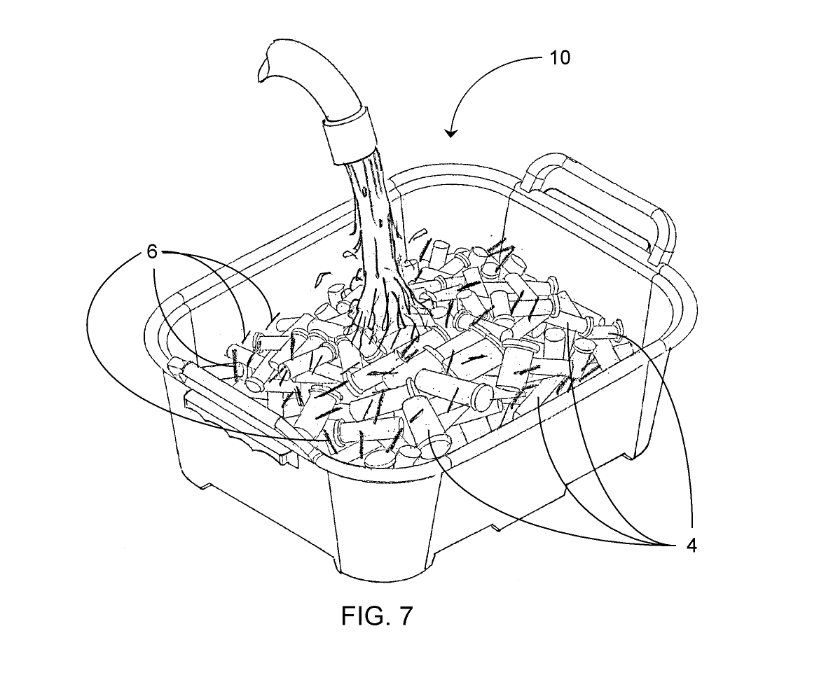

Referring next to FIG. 7, once the mixture 2 containing at least ammunition casings 4 and polishing media 6 has been emptied into the sifting apparatus 10, the mixture may be rinsed with water to clear any fluid 8 or remaining dirt or debris from the sifting apparatus 10. The plurality of holes 26 in the bottom surface 22 of the upper first container and the plurality of holes or, in some embodiments, mesh insert 46 in the bottom surface 42 of the lower second container permit any fluids 8 and debris to pass through the sifting apparatus 10 while the ammunition casings 4 and the polishing media 6 is retained by the sifting apparatus 10. Again, it is preferable to perform this step in the process over a draining device such as a sink to avoid spillage.

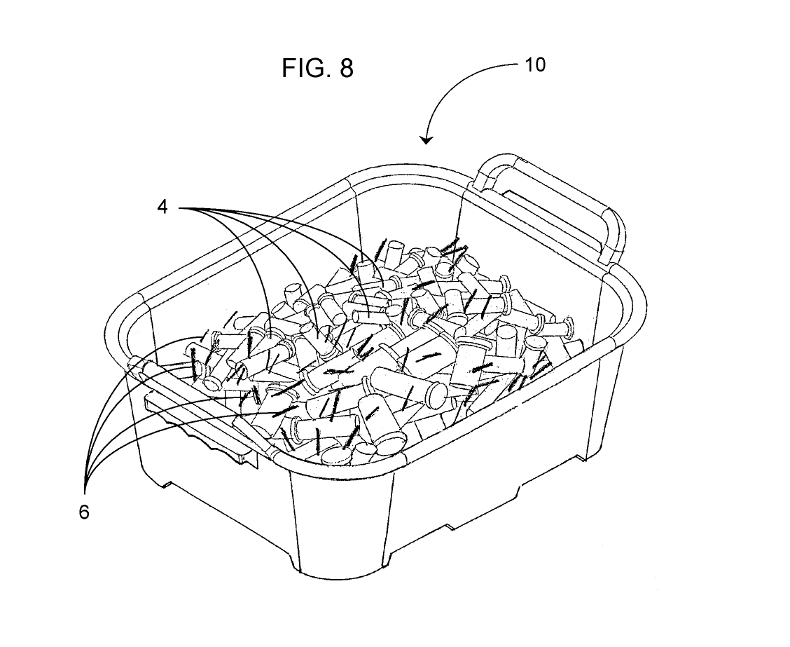

Referring next to FIG. 8, once the mixture 2 has been rinsed, all that should remain in the sifting apparatus 10 is the ammunition casings 4 and the polishing media 6. The mixture 2 is now ready to be separated using the sifting apparatus 10.

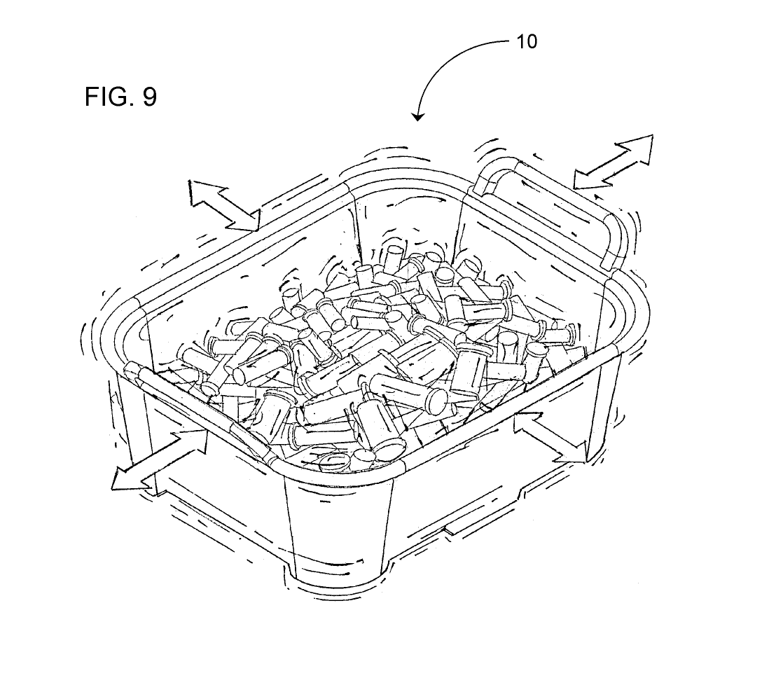

Referring next to FIG. 9, to separate the ammunition casings 4 from the polishing media 6, the sifting unit 10 is manipulated by shaking, stirring, etc., by hand or otherwise, to encourage the smaller sized polishing media 6 to pass through the plurality of holes 26 in the bottom surface 22 of the upper first container 20. Since the holes 26 are too small to permit the ammunition casings 4 from passing through, the casings 4 are retained in the upper first container 20 despite any amount of manipulation of the sifting apparatus 10. Those skilled in the art will appreciate the many effective uses of the sifting apparatus 10 presented.

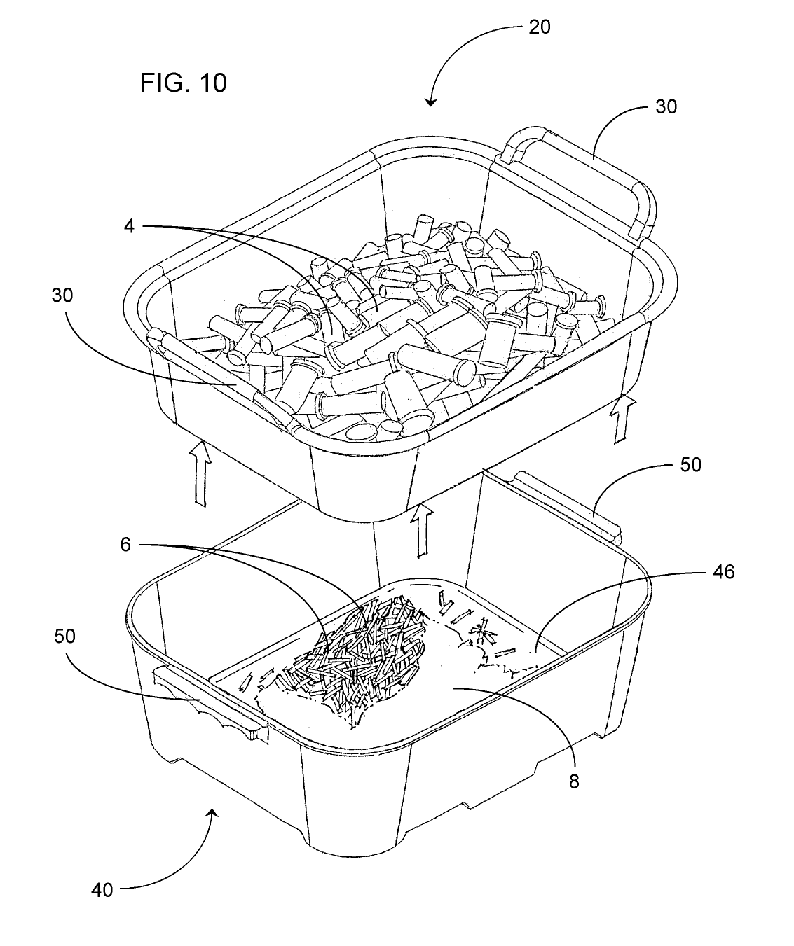

Referring last to FIG. 10, once the sifting apparatus 10 has been sufficiently manipulated such that the polishing media 6 has passed through the bottom surface 22 of the upper first container 20, the upper first container 20 can be separated from the lower second container 40 by lifting it up and away. In some embodiments, separation of the first and second containers is facilitated by handles 30 on the upper first container 20. As depicted in FIG. 10, the upper first container 20 is separated and contains only ammunition casings 4 while the polishing media 6 and any extraneous fluids 8 remain in the lower second container 40. Over time, all remaining fluids 8 will pass through the bottom surface 42 of the lower second container 40, comprised of a mesh insert 46 or otherwise, leaving only polishing media 6 in the lower second container 40. Thereby, the ammunition casings 4 can be quickly and easily removed from the upper first container 20 for reuse and the polishing media 6 can be quickly and easily removed from the lower second container 40 for reuse as well, thereby accomplishing certain objectives of the present technology. Once the first and second containers 20, 40 are cleared, they may be rinsed if necessary and placed back in the nested, single-unit state for storage until the next use.

While the present technology has been described with reference to particular embodiments and arrangements of parts, features, and the like, the present technology is not limited to these embodiments or arrangements. Indeed, many modifications and variations will be ascertainable to those of skill in the art, all of which are inferentially included in these teachings.

What is claimed is:

1. A two stage sifter for separating polishing media from polished casings, comprising:
an upper first container, said first container having a bottom surface with sidewalls extending upwardly therefrom to an upper opening, said first sidewalls having a height, said first container bottom surface being provided with a plurality of openings smaller than the polished casings and larger than the polishing media whereby the polished casings may be separated from the polishing media, said first container upper opening having a peripheral lip having a lip cross-sectional profile, said peripheral lip extending outwardly from said sidewalls;
a lower second container, said second container having a bottom surface with sidewalls extending upwardly therefrom to an upper opening, said bottom surface having a mesh insert having a plurality of openings which are smaller than the polishing media whereby the polishing media may be retained in the second container, said second container having a peripheral rim having a rim cross-sectional profile contoured to receive the first container peripheral lip cross-sectional profile, said peripheral rim extending outwardly from said sidewalls, said second container sidewalls having a height which is greater than said first sidewalls' height, whereby the first container may be nested within the second container with the first container peripheral lip seated in the second container peripheral rim, with a space between the first container bottom surface and the second container bottom surface.

2. The two stage sifter of claim 1, wherein the first container lip cross-sectional profile is circular and the peripheral lip is generally cylindrical; and the second container peripheral rim cross-sectional profile includes a curved groove for receiving the generally cylindrical peripheral lip.

3. The two stage sifter of claim 1, wherein said first container further comprises two handles extending upwardly from said first container peripheral lip.

4. The two stage sifter of claim 3, wherein said second container further comprises two handles extending laterally outwardly from said second container peripheral rim, each first container handle being generally vertically aligned with a corresponding second container handle.

5. The two stage sifter of claim 1, wherein the openings in the first container bottom surface have a maximum size of 0.25 inch in one dimension.

6. The two stage sifter of claim 1, wherein the openings in the second container mesh insert is a 20×20 mesh.

7. The two stage sifter of claim 1, further comprising stainless steel pins, said stainless steel pins being polishing media and being retained in said second container in the space between the first container bottom surface and the second container bottom surface.

8. The two stage sifter of claim 1, further comprising a plurality of feet provided on the second container.

9. The two stage sifter of claim 1, wherein the second container bottom surface or mesh insert are magnetic; and wherein the polished casings are brass ammunition casings being retained in the first container.

10. A two stage sifter for separating stainless steel pin polishing media from polished casings, comprising:
an upper first container, said first container having a bottom surface with sidewalls extending upwardly therefrom to an upper opening, said first sidewalls having a height, said first container bottom surface being provided with a plurality of openings having a maximum size of 0.250 inch in at least one dimension whereby the openings are smaller than the polished casings and larger than the stainless steel pin polishing media such that the polished casings may be separated from the polishing media, said first container upper opening having a peripheral lip having a lip cross-sectional profile which is circular and wherein the peripheral lip is generally cylindrical, said peripheral lip extending outwardly from said sidewalls;
a lower second container, said second container having a bottom surface with sidewalls extending upwardly therefrom to an upper opening, said bottom surface having a mesh insert having a plurality of openings which are smaller than the stainless steel pin polishing media whereby the stainless steel pin polishing media may be retained in the second container, said second container having a peripheral rim having a curved groove rim cross-sectional profile for receiving the generally cylindrical peripheral lip, said peripheral rim extending outwardly from said sidewalls, said second container sidewalls having a height which is greater that the first sidewalls' height, whereby the first container may be nested within the second container with the first container peripheral lip seated in the second container peripheral rim, with a space between the first container bottom surface and the second container bottom surface.

11. The two stage sifter of claim 10, wherein first container has two first container handles extending upwardly from said first container peripheral lip; and said second container has two second container handles extending laterally outwardly from said second container peripheral rim, each first container handle being generally vertically aligned with a corresponding second container handle.

12. The apparatus of claim 10, wherein said stainless steel pin polishing media is retained in said second container in the space between the first container bottom surface and the second container bottom surface.

13. The two stage sifter of claim 12, wherein the openings in the second container mesh insert is a 20×20 mesh.

14. The two stage sifter of claim 10, further comprising a plurality of feet provided on and extending downwardly from the second container.

15. A system for cleaning ammunition casings using stainless steel pin polishing media, comprising:
a rotary tumbler having a reclosable jar for receiving a mixture of ammunition casings, stainless steel pin polishing media, water, and optionally a detergent product, and a cradle having motor-driven wheels for rotating the jar to agitate the mixture;
an upper first container, said first container having a bottom surface with sidewalls extending upwardly therefrom to an upper opening, said first sidewalls having a height, said first container bottom surface being provided with a plurality of openings smaller than the casings and larger than the stainless steel pin polishing media whereby the casings may be separated from the stainless steel pin polishing media, said first container upper opening having a peripheral lip having a lip cross-sectional profile, said peripheral lip extending outwardly from said sidewalls;
a lower second container, said second container having a bottom surface with sidewalls extending upwardly therefrom to an upper opening, said bottom surface having a mesh insert having a plurality of openings which are smaller than the stainless steel pin polishing media whereby the stainless steel pin polishing media may be retained in the second container, said second container having a peripheral rim having a rim cross-sectional profile contoured to receive the first container peripheral lip cross-sectional profile, said peripheral rim extending outwardly from said sidewalls, said second container sidewalls having a height which is greater that the first sidewalls height, whereby the first container may be nested within the second container with the first container peripheral lip seated in the second container peripheral rim, with a space between the first container bottom surface and the second container bottom surface;
said stainless steel pins being retained in said second container in the space between the first container bottom surface and the second container bottom surface.

16. The system of claim 15, wherein said first container lip cross-sectional profile is circular and said peripheral lip is generally cylindrical; and said second container peripheral rim cross-sectional profile includes a curved groove for receiving said generally cylindrical peripheral lip.

17. The system of claim 16, wherein said first container further comprises two first container handles extending upwardly from said first container peripheral lip; and said second container has two second container handles extending laterally outwardly from said second container peripheral rim, each first container handle being generally vertically aligned with a corresponding second container handle.

18. The two stage sifter of claim 15, further comprising a plurality of feet provided on and extending downwardly from the second container.

19. A method for cleaning brass ammunition casings using stainless steel pin polishing media, comprising the steps of:
tumbling a mixture of brass ammunition casings, stainless steel pin polishing media, water, and optionally, cleaning products, in a reclosable jar seated in motor-driven wheels of a rotary tumbler to agitate the mixture;
transferring the mixture to an upper first container, said first container having a bottom surface with sidewalls extending upwardly therefrom to an upper opening, said first sidewalls having a height, said first container bottom surface being provided with a plurality of openings smaller than the casings and larger than the stainless steel pin polishing media, said first container upper opening having a peripheral lip having a lip cross-sectional profile, said peripheral lip extending outwardly from said sidewalls;
agitating the first container whereby the casings are separated from the stainless steel pin polishing media and retained in the first container while the stainless steel pin polishing media escapes from the first container through the plurality of openings;
collecting the stainless steel pin polishing media in a lower second container, said second container having a bottom surface with sidewalls extending upwardly therefrom to an upper opening, said bottom surface having a magnetic mesh insert having a plurality of openings which are smaller than the polishing media, said second container having a peripheral rim having a rim cross-sectional profile contoured to receive the first container peripheral lip cross-sectional profile, said peripheral rim extending outwardly from said sidewalls, said second container sidewalls having a height which is greater that the first sidewalls height, whereby the first container may be nested within the second container with the first container peripheral lip seated in the second container peripheral rim, with a space between the first container bottom surface and the second container bottom surface, whereby the stainless steel pin polishing media is collected in the second container in the space between the first container bottom surface and the second container bottom surface while the water and optional cleaning products are drained from the second container through the mesh insert;
separating the first container containing the casings from the second container containing the stainless steel pin polishing media.

20. A method of separating stainless steel pin polishing media from ammunition casings, comprising the steps of:
providing two stage sifter including:
an upper first container, said first container having a bottom surface with sidewalls extending upwardly therefrom to an upper opening, said first sidewalls having a height, said first container bottom surface being provided with a plurality of openings having a maximum size of 0.250 inch in at least one dimension whereby the openings are smaller than the casings and larger than the stainless steel pin polishing media such that the casings may be separated from the stainless steel pin polishing media, said first container upper opening having a peripheral lip having a lip cross-sectional profile which is circular and wherein the peripheral lip is generally cylindrical, said peripheral lip extending outwardly from said sidewalls; and
a lower second container, said second container having a bottom surface with sidewalls extending upwardly therefrom to an upper opening, said bottom surface having a mesh insert having a plurality of openings which are smaller than the stainless steel pin polishing media whereby the stainless steel pin polishing media may be retained in the second container, said second container having a peripheral rim having a curved groove rim cross-sectional profile for receiving the generally cylindrical peripheral lip, said peripheral rim extending outwardly from said sidewalls, said second container sidewalls having a height which is greater that the first sidewalls height, whereby the first container may be nested within the second container with the first container peripheral lip seated in the second container peripheral rim, with a space between the first container bottom surface and the second container bottom surface;
wherein said first container has two first container handles extending upwardly from said first container peripheral lip; and said second container has two second container handles extending laterally outwardly from said second container peripheral rim, each first container handle being generally vertically aligned with a corresponding second container handle;
placing a mixture of stainless steel pin polishing media, ammunition casings, and optionally water and cleaning products into the first container;
holding the two first container handles and the two second container handles and agitating the two stage sifter such that the stainless steel pin media passes through the plurality of openings in the bottom surface of the first container and the ammunition casings are retained in the first container;
separating the first container from the second container.
